(19) United States
(12) Patent Application Publication
(10) Pub. No.: US 2005/0255910 A1
(43) Pub. Date: Nov. 17, 2005

(54) Prizewinner generating system and method and recording medium

(75) Inventor: Ying Hung Chou, Shindian City (TW)

Correspondence Address: BACON & THOMAS, PLLC, 625 SLATERS LANE, FOURTH FLOOR, ALEXANDRIA, VA, 22314, US

(73) Assignee: VIA Technologies, Inc., Shindian City (TW)

(21) Appl. No.: 10/950,435

(22) Filed: Sep. 28, 2004

(30) Foreign Application Priority Data
May 13, 2004 (TW) 093113521

(51) Int. Cl. G06F 17/00; G06F 19/00; G10H 1/22; G10H 7/00

(52) U.S. Cl. 463/22

(57) ABSTRACT

A prizewinner generating system comprises a targeted serial-number generating module and a data-retrieving module. The targeted serial-number generating module generates a targeted serial number according to a random method. The data-retrieving module retrieves one from a plurality of candidates for generating a required prizewinner. In addition, a prizewinner generating method and a recording medium, which records a computer readable program for performing the prizewinner generating method, are provided. According to the system and method, the required prizewinner can be generated fairly and quickly, and can be retrieved corresponding to any special expectancy efficiently.

### BACKGROUND OF THE INVENTION

1. Field of Invention

The invention relates to a prizewinner generating system and method and, in particular, to a prizewinner generating system and method, which can retrieve one from a plurality of data (candidates).

2. Related Art

Accompanying the development of global economy, group management enterprises have become one of the most important industry managing models. Therefore, when the skilled person would like to determine one from a plurality of data according to the organizations, companies and/or other groups, the data set may not be generated by fairly way due to the weights of different departments of the group management enterprise are differ from each other. In addition, it is hard to design a method, which can also retrieve the required one of data corresponding to any special expectancy. For example, in Taiwan, every company always holds a year-end celebration, and the most important action is the “year-end lucky draw”. In conventional, large amount draw tickets should be pre-printed for the “year-end lucky draw” action. At first, every employee gets a receipt of the draw ticket, and the draw sponsor collects the corresponding stubs of the draw tickets and draws one stub for the prize. Then, the employee (prizewinner) can go get the prize from the sponsor according to the receipt having the same serial number as that of the drawn stub. This drawing method, however, is time waste and needs a lot of manpower. In addition, the drawing method has to pre-print the draw tickets, which not only spends lots of money but also is against the environmental protection. Thus, it is a workable substitute project to utilize an electrical system for generating the required prizewinner.

As mentioned above, since the present industry managing model may be a group management enterprise, the lucky draw action of the whole group always utilizes “weight method” to process the lucky drawing. That is, the company or organization, which is more important or has more employees, may be distributed more prizes on purpose. Accordingly, the prizewinning probabilities for the employees are different, since the weights of the original data are different.

### SUMMARY OF THE INVENTION

The invention provides a prizewinner generating system, comprising a targeted serial-number generating module for generating a targeted serial number according to a random method, and a data-retrieving module for retrieving one candidate from a plurality of candidates to generate a prizewinner according to the targeted serial number.

The invention also provides a prizewinner generating method, comprising the following steps of: changing the order of a plurality of original data to generate a plurality of re-sorted data; generating a corresponding random number combination according to the amount of the re-sorted data; and retrieving corresponding one of the re-sorted data according to the random number combination in turn to generate the prizewinner.

The invention further provides a recording medium, which records a computer readable prizewinner generating program. The program comprises a data inputting program segment for the computer to input a plurality of original data, a data sorting program segment for the computer to re-sort the original data in a random method so as to generate a plurality of sorted data, a random number combination generating program segment for the computer to generate a random number combination according to the sorted data, and a data retrieving program segment for the computer to retrieve one of the sorted data according to the random number combination.

According to the system and method, the required prizewinner can be generated fairly and quickly, and can be retrieved corresponding to any special expectancy efficiently. In other words, the system and method of the invention randomly generate the data to be retrieved and randomly retrieve one of the data. For example, the targeted serial number is generated according to a random method, the random number combination is randomly generated, and the retrieved data is retrieved according to the random number. Thus, the probability for retrieving each of the data approaches to an average, so as to generate the desired prizewinner fairly and quickly. Alternatively, the prizewinner generating system and method of the invention can retrieve the prizewinner corresponding to any special expectancy efficiently. For example, a valued serial number can be added to some data indicating those having special contributions, and the prizewinner is then retrieved according to the valued serial number. Thus, the invention can generate the prizewinner corresponding to the requirement for special weightings.

### BRIEF DESCRIPTION OF THE DRAWINGS

The invention will become more fully understood from the detailed description given hereinbelow illustration only, and thus is not limitative of the present invention, and wherein:

FIG. 1 is a schematic view showing a prizewinner generating system 1 according to a preferred embodiment of the invention, which illustrates the configuration thereof;

FIG. 2 is a schematic view showing a prizewinner generating system 2 according to another preferred embodiment of the invention, which illustrates the detail structure and configuration thereof;

FIG. 3 shows an example of the prizewinner generating system according to another preferred embodiment of the invention, which is for the detail description of this embodiment; and

FIG. 4 is a flow chart showing the steps of a prizewinner generating method according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

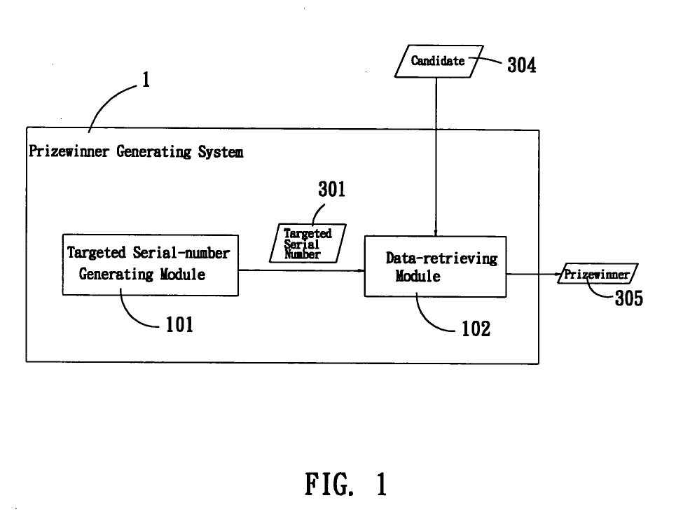

FIG. 1 is a schematic view showing a prizewinner generating system 1 according to a preferred embodiment of the invention. The prizewinner generating system 1 comprises a targeted serial-number generating module 101 for generating a targeted serial number according to a random method; and a data-retrieving module 102 for retrieving one candidate from a candidate set, which includes a plurality of candidates, to generate a prizewinner according to the targeted serial number. For example, the targeted serial-number generating module 101 determines the number of digits of the targeted serial number according to the amount of the candidates, wherein the order of a plurality of original data is re-sorted to generate the candidates. In this case, when the maximum employee number is 500, the amount of the candidates is 500. In the embodiment, the number of the digits of the targeted serial number is 3, so that the targeted serial-number generating module 101 generates three digits randomly in turn, such as “0”, “0” and “4”, and then combines the digits to generate a targeted serial number, such as “004”. After that, the data-retrieving module 102 retrieves one candidate from the corresponding position of a candidate set (e.g. the fourth candidate of the candidate set) according to the targeted serial number (e.g. 004) to generate an output result of the prizewinner generating system 1.

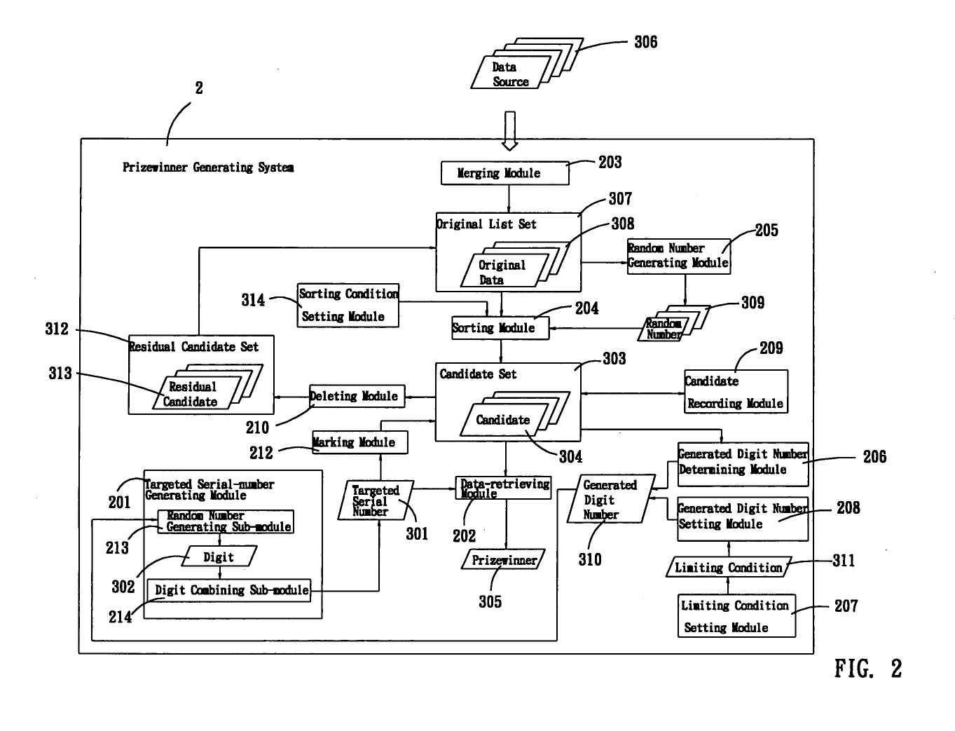

With reference to FIG. 2, FIG. 2 is a schematic view showing a prizewinner generating system 2 according to another preferred embodiment of the invention, which illustrates the detail structure of the prizewinner generating system according to the embodiment of the invention. Firstly, the targeted serial-number generating module 201 (corresponding to the targeted serial-number generating module 101 shown in FIG. 1) generates a targeted serial number 301 according to a random method, and further comprises a random number generating sub-module 213 and a digit combining sub-module 214. In such a case, the random number generating sub-module 213 generates each digit 302 of the targeted serial number 301 in turn. The digit combining sub-module 214 combines the digits 302 generated by the random number generating sub-module 213 so as to generate the targeted serial number 301. For example, the random number generating sub-module 213 respectively generates three digits, such as “1”, “3” and “5”, and the digit combining sub-module 214 combines the three digits to generate the targeted serial number, such as “135”. The data-retrieving module 202 (corresponding to the data-retrieving module 102 shown in FIG. 1) retrieves one candidate 304 from a candidate set 303, which includes a plurality of candidates 304, to generate a prizewinner 305 according to the targeted serial number 301.

In addition, referring to FIG. 2, considering the source of the candidates, a merging module 203 receives a plurality of data sources 306, and merges the data sources 306 to generate and output an original list set 307. Wherein, the original list set 307 may further include a plurality of original data 308. In the present embodiment, the data sources 306 may come from several sub-companies of the same group respectively, and the original data 308 are the employee data of the sub-companies.

A sorting module 204 receives the original list set 307 outputted from the merging module 203 and changes the order of the original data 308 in the original list set 307 to generate the candidate set 303. For example, the sorting module 204 changes the order of the employee data of each sub-company. The sorting module 204, for instance, may continuously generate a number according to a random method, and the generated number represents which one of the employee data is to be considered as a candidate 304. Therefore, the candidates 304 of the generated candidate set 303 are the employee data with changed orders, which are randomly sorted.

A random number generating module 205 generates a random number 309 according to the original list set 307, wherein the digits of the random number 309 corresponds to the amount of the original data 308 of the original list set 307. The sorting module 204 selects one of the original data 308 in turn to complete the candidate set 303 according to the random number 309. In the embodiment, each candidate 304 includes a serial number, which is an index of the corresponding candidate 304.

A generated digit number determining module 206 determines a generated digit number 310 according to the digit number of the serial number of each candidate 304. Moreover, a limiting condition setting module 207 sets a limiting condition 311. For example, under an application allowing of setting weight and classification, the limiting condition 311 can be that of setting several digits with constant digits, which are not randomly determined for those senior and/or having special contribution, so that the seniors have higher probability to be drawn out. Then, a generated digit number setting module 208 sets a generated digit number 310 according to the limiting condition 311. In this embodiment, the generated digit number 310 can be determined by the generated digit number determining module 206, and can also be determined by the limiting condition setting module 207 and generated digit number setting module 208. That is, the prizewinner generating system may comprise all of the generated digit number determining module 206, the limiting condition setting module 207 and the generated digit number setting module 208. Alternatively, it can comprise the generated digit number determining module 206 only and exclude the limiting condition setting module 207 and the generated digit number setting module 208, or comprise the limiting condition setting module 207 and the generated digit number setting module 208 and exclude the generated digit number determining module 206.

Furthermore, a candidate recording module 209 is used to record the candidate set 303. In the embodiment, the candidate recording module 209 can be a DRAM, an SRAM, a hard disc drive, and the likes. A deleting module 210 deletes the retrieved candidate 304 retrieved from the candidate set 303 according to the targeted serial number 301 so as to generate a residual candidate set 312 including a plurality of residual candidates 313. In other words, after one prizewinner is generated, the candidate 304 corresponding to the prizewinner is deleted from the candidate set 303 so as to generate the residual candidate set 312, which is for further updating the original list set 307 for the later generating procedure of the next prizewinner. It should be noted that the deleting procedure of the prizewinner by the deleting module 210 could be replaced by utilizing a marking module 212 to attach a mark to the retrieved candidate 304 according to targeted serial number 301. Then, the data-retrieving module 202 can generate the prizewinner 305 according to the mark. In other words, the data-retrieving module 202 can search the candidate set 303 to retrieve the candidate 304 with the mark, which constructs the prizewinner 305.

It should be noted that the prizewinner generating system of the invention could be implemented in an electronic apparatus, such as a conventional computer that includes a central processing unit (CPU), a storage device, an input device and an output device. The CPU could be in any conventional architecture, such as including an arithmetic logic unit (ALU), a register and a controller, for performing various kinds of operations and to control the operations of other devices in the electronic apparatus. The storage device could be anyone or the combination of computer-readable data storage devices, such as a hard disc drive, an optical disc drive, a dynamic random access memory (DRAM), an electrically erasable programmable read-only memory (EEPROM), or the combinations thereof. The input device could be any device that allows a user to input data or instructions to the electronic apparatus, such as a keyboard, a mouse, or an USB interface. The output device could be a display device or an USB interface for outputting the generated prizewinner.

The modules of the present embodiment could be software modules stored in the storage device. The CPU accesses the software modules, and realizes the functions of the modules through the devices in the electronic apparatus, such as the input device, the storage device, the output device or other software modules. However, it should be noted that persons having ordinary skill in the art may design firmware or hardware, such as an application-specific integrated circuit (ASIC), to realize the function of the software modules mentioned above without departing from the spirit and the scope of the invention.

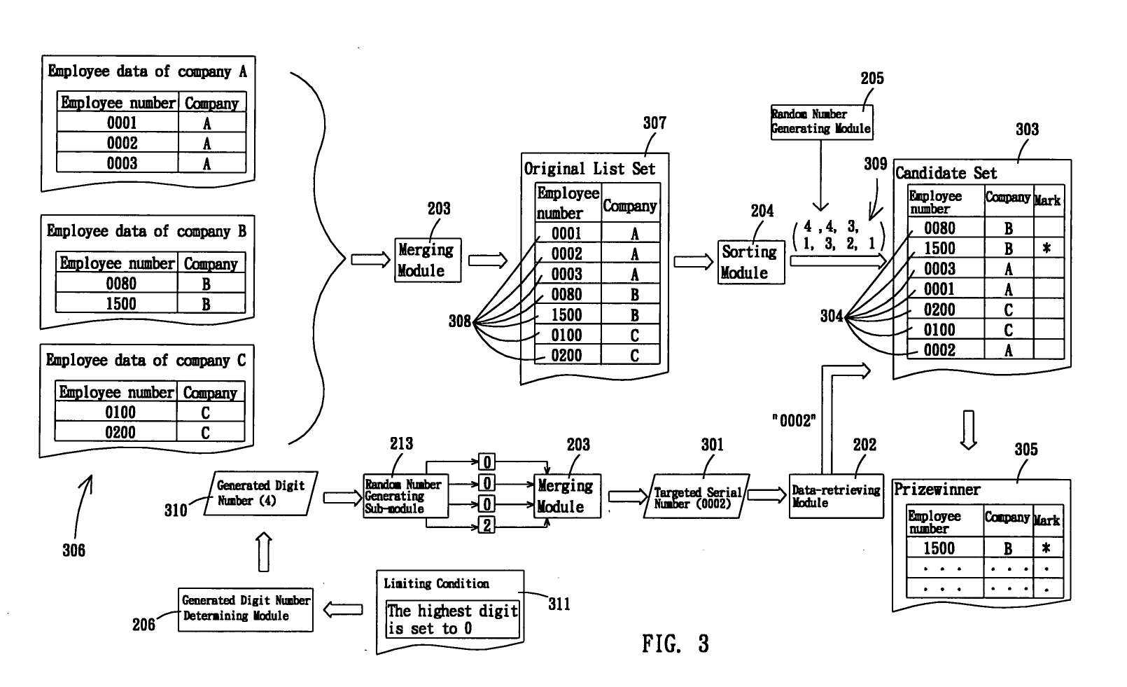

To make the invention more comprehensive, an example of the prizewinner generating system according to the another embodiment of the invention is described hereinafter. FIG. 3 shows the example of the prizewinner generating system, which relates to a group containing three sub-companies (companies A, B and C). The data sources 306 come from the employee data of the companies A, B and C. Then, the merging module 203 receives original data 308 constructed by the employee data to generate an original list set 307. Wherein, the content of the original list set 307 can be tables and/or files.

Then, a sorting module 204 changes the orders of the original data 308 in the original list set 307 to generate a candidate set 303. In addition, for the weight set application, a sorting condition setting module 314 is used to set some original data having prior serial number. Moreover, a random number generating module 205 is used to generate a random number 309 continuously, so as to determine which original data 308 of the original list set 307 should be moved or copied to the candidate set 303. For example, if the first generated random number is 4, the fourth of the original data 308 is to be moved and becomes the first candidate 304 of the candidate set 303. If the second generated random number is 4, the fourth of the original data 308 is to be moved and becomes the second candidate 304 of the candidate set 303. According to this manner, a complete candidate set 303 is generated.

The candidate recording module 209 is used to record the candidate set 303, and can be a recording module such as a DRAM, an SRAM, a hard disc drive, and the likes. In addition, a targeted serial-number generating module 201 generates a targeted serial number 301, wherein a random number generating sub-module 213 generates each digit of the targeted serial number 301 in turn, and the digit combining sub-module 214 combines the digits to generate the targeted serial number 301. The data-retrieving module 202 retrieves one candidate 304 as a prizewinner 305 from a candidate set 303. For example, the random number generating sub-module 213 respectively generates four digits, such as “0”, “0”, “0” and “2”, and the digit combining sub-module 214 combines the four digits to generate the targeted serial number, such as “0002”. Then, the data-retrieving module 202 retrieves the second candidate 304 from the candidate set 303 according to the targeted serial number (0002) to generate the prizewinner 305. In addition, if considering the flexibility of the system in application, e.g. allowing of setting weight and classification, the operating times of the random number generating sub-module 213 is determined according to the generated digit number 310. In this case, the generated digit number determining module 206 determines a generated digit number 310 according to the digit number of the serial number of each candidate 304. If there are, for example, 2000 candidates, the digit number of the serial number is 4, so that the generated digit number 310 is 4. Therefore, a targeted serial number 301 including 4 digits is then generated. In addition, under an application allowing of setting weight and classification, a limiting condition setting module 207 can set several digits with constant digits, which are not randomly determined corresponding to the condition set by a sorting condition setting module 314 for the a sorting module 204. Thus, the generated digit number setting module 208 sets a generated digit number 310 according to the limiting condition 311. The operating times of the random number generating sub-module 213 is determined according to the generated digit number 310, so as to generate the targeted serial number 301 having the corresponding digit number. For example, when the system is applied for the employees of the sub-company, which is more contributive to the income of the group, or for the senior employees, who are qualified to the special weight condition, the limiting condition 311 can be set to include several digits with constant digits, which are not randomly determined. Thus, the weighted employees have higher probability to be drawn out. Accordingly, the generated digit number 310 can be determined by the generated digit number determining module 206, and can also be determined by the limiting condition setting module 207 and generated digit number setting module 208.

When the prizewinner 305 is firstly generated, a deleting module 210 is used to delete the corresponding candidate 304 from the candidate set 303 so as to generate a residual candidate set 312. The generate the residual candidate set 312 is for further updating the original list set 307 for the next prizewinner generating procedure. Alternatively, when the prizewinner 305 is firstly generated, a marking module 212 attaches a mark, such as “*”, to the corresponding candidate 304. Then, the data-retrieving module 202 can output all candidates 304 with the marks so as to construct the prizewinner 305. In addition, other candidates 304 without the marks can be used to generate the next prizewinner.

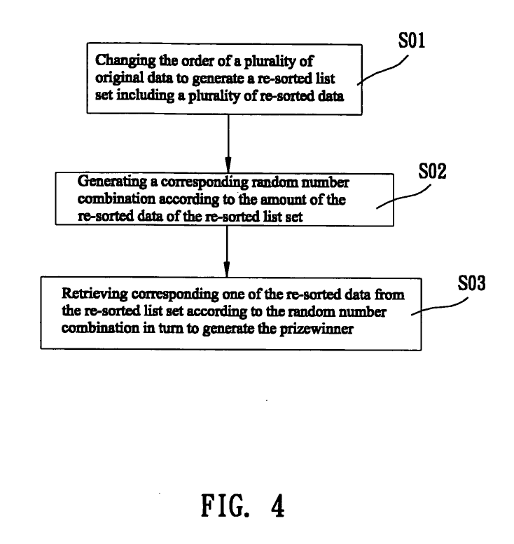

FIG. 4 is a flow chart showing the steps of a prizewinner generating method according to a preferred embodiment of the invention. Firstly, the step S01 changes the order of a plurality of original data to generate a re-sorted list set including a plurality of re-sorted data In the present embodiment, the step S01 generates a random number according to the re-sorted list set, wherein the digits of the random number corresponds to the amount of the original data of the re-sorted list set. The random number is then for the step to change the order of the original data.

Next, the step S02 generates a corresponding random number combination according to the amount of the re-sorted data of the re-sorted list set. In the embodiment, the step S02 for generating the corresponding random number may include the following sub-steps of: calculating a digit number according to the amount of the re-sorted data of the re-sorted list set, generating the value of each digit of the random number, and combining the values of the digits of the random number to generate the corresponding random number combination.

Finally, the step S03 retrieves corresponding one of the re-sorted data from the re-sorted list set according to the random number combination in turn to generate the prizewinner. In this embodiment, the step S03 may include the following sub-steps of taking the corresponding random number combination as a prizewinner serial number, and retrieving one of the corresponding re-sorted data having a targeted serial number equivalent to the prizewinner serial number to generate the prizewinner. Alternatively, the step S03 may include the following sub-steps of taking the corresponding random number combination as a prizewinner serial number, attaching a valued mark to one of the re-sorted data, and outputting the marked one of the re-sorted data including the valued mark to generate the prizewinner.

Besides, the prizewinner generating method according the embodiment of the invention may further comprises the following steps of deleting the retrieved one of the re-sorted data from the re-sorted list set, wherein the residual re-sorted data of the re-sorted list set is used to be a plurality of original data for executing the prizewinner generating method again to generate a next prizewinner.

The invention further provides a recording medium, such as a compact disc, a floppy disc, or a swappable hard disc drive, for recording a computer readable prizewinner generating program so as to execute the above-mentioned prizewinner generating method. Herein, the prizewinner generating program recorded in the recording medium is basically constructed by several program segments, which correspond to the functions mentioned in the method of the above embodiment.

As mentioned above, the program comprises a data inputting program segment, a data sorting program segment, a random number combination generating program segment, and a data retrieving program segment. The data inputting program segment is for the computer to input a plurality of original data. The data sorting program segment is for the computer to re-sort the original data in a random method so as to generate a plurality of sorted data. The random number combination generating program segment is for the computer to generate a random number combination according to the sorted data. The data retrieving program segment is for the computer to retrieve one of the sorted data according to the random number combination. In this case, the retrieved one of the sorted data is used for generating the prizewinner. In the present embodiment, the data inputting program segment may be further for the computer to input a plurality of candidate sets, which respectively include a plurality of candidates. Accordingly, the sorted data includes the candidates and a plurality of serial numbers corresponding to the candidates. The data retrieving program segment is for the computer to retrieve one of the sorted data, which has a corresponding serial number equivalent to the random number combination, for the prizewinner.

In addition, the prizewinner generating program may further comprise a valued serial-number adding program segment, which is for the computer to add a valued serial number to the retrieved one of the sorted data having a serial number equivalent to the random number combination. Then, the sorted data can be searched for retrieving one of the sorted data having the valued serial number as the prizewinner. Besides, the prizewinner generating program may further comprise a data deleting program segment, which is for the computer to delete the retrieved one from the sorted data.

As mentioned above, the prizewinner generating program may further comprises an outputting program segment, which is for the computer to output the retrieved one of the sorted data. In the current embodiment, the data retrieving program segment is for the computer to retrieve one of the residual sorted data, and the outputting program segment is then for the computer to output the retrieved one of the sorted data. Besides, the data sorting program segment may be further for the computer to re-sort the residual original data in a random method so as to generate a plurality of sorted residual data. The data retrieving program segment may be further for the computer to retrieve one of the sorted residual data according to another random number combination. Then, the outputting program segment is for the computer to output the retrieved one of the sorted residual data for generating a next prizewinner.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A prizewinner generating system, comprising:
a targeted serial-number generating module, which generates a targeted serial number according to a random method; and
a data-retrieving module, which retrieves one candidate from a candidate set to generate a prizewinner according to the targeted serial number, wherein the candidate set includes a plurality of candidates.

2. The prizewinner generating system of claim 1, further comprising:
a merging module, which receives a plurality of data sources to generate an original list set, wherein the original list set includes a plurality of original data; and
a sorting module, which receives the original list set and changes the order of the original data in the original list set to generate the candidate set.

3. The prizewinner generating system of claim 2, further comprising:
a random number generating module, which generates a random number according to the original list set, wherein the digits of the random number corresponds to the amount of the original data of the original list set, and the sorting module selects one of the original data in turn to complete the candidate set according to the random number.

4. The prizewinner generating system of claim 2, further comprising:
a sorting condition setting module, which controls a sorting condition of the sorting module according to a limiting condition.

5. The prizewinner generating system of claim 1, wherein each of the candidates comprises:
a serial number, which is an index value of the corresponding candidate.

6. The prizewinner generating system of claim 5, further comprising:
a generated digit number determining module, which determines a generated digit number according to the digit number of the serial number.

7. The prizewinner generating system of claim 5, further comprising:
a limiting condition setting module, which sets a limiting condition; and
a generated digit number setting module, which sets a generated digit number according to the limiting condition.

8. The prizewinner generating system of claim 1, wherein the targeted serial-number generating module comprises:
a random number generating sub-module, which generates each digit of the targeted serial number in turn; and
a digit combining sub-module, which combines the digits to generate the targeted serial number.

9. The prizewinner generating system of claim 1, further comprising:
a deleting module, which deletes the retrieved candidate retrieved from the candidate set according to the targeted serial number so as to generate a residual candidate set including a plurality of residual candidates.

10. The prizewinner generating system of claim 1, further comprising:
a marking module, which attaches a mark to one of the candidates according to the targeted serial number, wherein the data-retrieving module to generate the prizewinner according to the mark.

11. A prizewinner generating method, comprising:
changing the order of a plurality of original data to generate a re-sorted list set including a plurality of re-sorted data;
generating a corresponding random number combination according to the amount of the re-sorted data of the re-sorted list set; and
retrieving corresponding one of the re-sorted data from the re-sorted list set according to the random number combination in turn to generate the prizewinner.

12. The prizewinner generating method of claim 11, further comprising:
generating a random number according to the re-sorted list set, wherein the digits of the random number correspond to the amount of the original data of the re-sorted list set, and the random number is for the step to change the order of the original data.

13. The prizewinner generating method of claim 11, wherein the step of generating the corresponding random number combination comprises:
calculating the number of digits of the random number combination according to the amount of the re-sorted data of the re-sorted list set;
generating the value of each digit of the random number combination; and
combining the values of the digits of the random number combination to generate the corresponding random number combination.

14. The prizewinner generating method of claim 11, further comprising:
taking the corresponding random number combination as a prizewinner serial number; and
retrieving one of the corresponding re-sorted data having a targeted serial number equivalent to the prizewinner serial number so as to generate the prizewinner.

15. The prizewinner generating method of claim 11, further comprising:
taking the corresponding random number combination as a prizewinner serial number;
attaching a valued mark to one of the re-sorted data; and
outputting the one of the re-sorted data including the valued mark to generate the prizewinner.

16. The prizewinner generating method of claim 11, further comprising:
deleting the retrieved one of the re-sorted data from the re-sorted list set, wherein the residual re-sorted data of the re-sorted list set is for generating a next prizewinner.

17. A recording medium, which records a computer readable prizewinner generating program, the program comprising:
a data inputting program segment, which is for the computer to input a plurality of original data;
a data sorting program segment, which is for the computer to re-sort the original data in a random method so as to generate a plurality of sorted data;
a random number combination generating program segment, which is for the computer to generate a random number combination according to the number of the sorted data; and
a data retrieving program segment, which is for the computer to retrieve one of the sorted data according to the random number combination.

18. The recording medium of claim 17, further comprising:
a valued serial-number adding program segment, which is for the computer to add a valued serial number to the one of the sorted data having a serial number equivalent to the random number combination.

19. The recording medium of claim 17, further comprising:
a data deleting program segment, which is for the computer to delete the retrieved one from the sorted data.

20. The recording medium of claim 17, further comprising:
an outputting program segment, which is for the computer to output the retrieved one of the sorted data.
